(19) United States
(12) Patent Application Publication
(10) Pub. No.: US 2013/0195474 A1
(43) Pub. Date: Aug. 1, 2013

(54) IMAGE-FORMING APPARATUS AND METHOD FOR CONTROLLING IMAGE-FORMING APPARATUS

(71) Applicant: Kyocera Document Solutions Inc., Osaka (JP)

(72) Inventor: Kenji MIYAMOTO, Osaka (JP)

(73) Assignee: KYOCERA DOCUMENT SOLUTIONS INC., Osaka (JP)

(21) Appl. No.: 13/754,205

(22) Filed: Jan. 30, 2013

(30) Foreign Application Priority Data
Jan. 31, 2012 (JP) 2012-018035

(51) Int. Cl. G03G 15/00

(52) U.S. Cl. CPC G03G 15/70
USPC 399/19; 399/21; 399/18

(57) ABSTRACT

An image-forming apparatus includes an image formation section, a placement unit, a paper feed rotating body, a detecting body, a storage unit, and a determination unit. The detecting body detects the arrival of the paper having been supplied by the paper feed rotating body. The storage unit stores measurement data that is based on a measurement time from the start of paper feeding until when the detecting body detects the arrival. The determination unit finds the average time of the measurement times and, when the average time is longer than a predetermined theoretical time, establishes as the paper-non-feed jam detection time a time obtained by adding the absolute value of the time difference between the theoretical time and the average time to a detection reference time. The determination unit determines whether or not a paper-non-feed jam has occurred with the paper-non-feed jam detection time.

This application is based upon and claims the benefit of priority from the corresponding Japanese Patent Application No. 2012-018035 filed Jan. 31, 2012, the entire contents of which are incorporated herein by reference.

### BACKGROUND

The present disclosure relates to an image-forming apparatus for determining whether or not paper has been fed from a paper feed unit (for detecting a paper-non-feed jam).

In general, an image-forming apparatus has a paper feed unit for accommodating paper to be used in printing, and for issuing one sheet of paper at a time. In some cases, a sensor is provided downstream of the paper feed unit in a paper conveyance direction, and the sensor detects whether or not paper has been fed; when paper has not been fed properly, then a paper-non-feed jam has occurred, and print-related operations of the image-forming apparatus are discontinued. At this time, a roller is in contact with the paper and therefore abrades; a greater cumulative total of operation time of the roller correlates to a tendency for a decline in the paper feed capacity and conveyance capacity. In view whereof, the cumulative total of operation time of the roller has been attracting focus, and there are known techniques where, when the cumulative total of operation time is longer, the detection time for a paper-non-feed jam is correspondingly lengthened.

More specifically, a known paper feed apparatus is provided with: paper-feeding means for separating and conveying recording paper one sheet at a time; measuring means for measuring the drive time (cumulative total time of operation) of the paper-feeding means; acquiring means for acquiring a reference table in which at least drive times of the paper-feeding means and detection timer values of a paperless jam (paper-non-feed jam) are associated with each other; specifying means for specifying a paperless jam detection timer value on the basis of the drive time and the reference table; and determining means for determining whether or not a paperless jam (paper-non-feed jam) has occurred, on the basis of the specified paperless jam detection timer value.

In the image-forming apparatus, a paper-non-feed jam, which occurs when paper has not been fed from the paper feed unit, is determined to have occurred when the sensor does not detect the arrival of paper even though a paper-non-feed jam detection time has elapsed since the start of paper feeding (a rotating body starts to rotate). When a paper-non-feed jam error is determined to have occurred, print-related operations in the image-forming apparatus, such as paper feeding, paper conveyance, and image formation, are discontinued. Jam processes performed by a user in the event of a paper-non-feed jam (checking the paper, or the like) are also carried out.

There are many factors contributing to paper feed delays (factors contributing to paper-non-feed jams). For example, the possibility that a paper-non-feed jam may take place is affected by the state in which the paper has been positioned, and by the degree to which the paper having been positioned is prone to slipping (the smallness of the coefficient of friction). The cumulative total time of operation of the roller for paper feeding (the extent of abrasion) also has an effect on whether or not a paper-non-feed jam occurs. Greater susceptibility to paper-non-feed jams may be seen in individual cases, while individual differences also exist between image-forming apparatuses.

In the event that a tendency for paper feeding (issuing forth of the paper) to be delayed becomes apparent, then when the paper-non-feed jam detection time is fixed, the occurrence of a paper-non-feed jam will be frequently detected and printing will be frequently discontinued. The detection of frequent paper-non-feed jams in excess of what is needed compels the user to frequently perform tasks for handling a paper-non-feed jam. Also, it is not preferable for the paper-non-feed jam detection time to be established as being uniform in all types of image-forming apparatuses, because of the fact that there are a variety of factors for a paper-non-feed jam to occur (for paper feeding to be delayed) and the fact that individual differences between image-forming apparatuses and between paper feed units exist, as described above. However, a problem emerges in that paper-non-feed jam detection times that are proper depending on the present condition, the actual paper feed, and the circumstances of conveyance have not been established.

Thus, in the above-described known paper feed apparatus, a paperless jam detection timer value (paper-non-feed jam detection time) is established on the basis of the cumulative total of operation time of the paper-feeding means. However, in some cases, the abrasion of the roller has progressed beyond what was expected. Moreover, even though the roller may not have abraded, sullying of the roller (for example, adhesion of paper dust) sometimes also causes slipping to be more prone to take place. In the known paper feed apparatus, no consideration whatsoever is given to individual differences, and the paper-non-feed jam detection time is established as being uniform for all apparatuses in accordance with the cumulative total time of operation of the paper-feeding means. With no consideration being given to the actual paper feed nor to the circumstances of conveyance, there are therefore some cases where paper-non-feed jams are frequently detected in excess of what is needed, and a proper (optimal) paper-non-feed jam detection time cannot be set.

### SUMMARY

In order to resolve the foregoing problems, an image-forming apparatus as in a first aspect of the present disclosure includes an image formation section, a placement unit, a paper feed rotating body, a detecting body, a storage unit, and a determination unit. The image formation section forms an image. A plurality of sheets of paper to be used in printing are placed on the placement unit. The paper feed rotating body feeds the paper placed on the placement unit towards the image formation section. The detecting body is provided to a paper conveyance path between the image formation section and the paper feed rotating body, and detects the arrival of the paper having been supplied by the paper feed rotating body. The storage unit stores measurement data that is based on a measurement time, which is a time from the start of paper feeding due to the start of rotation of the paper feed rotating body until when the detecting body detects the arrival of the paper. The determination unit determines whether or not a paper-non-feed jam has occurred on the basis of a paper-non-feed jam detection time, finds the average time of the measurement times, establishes as the paper-non-feed jam detection time a time obtained by adding the absolute value of the time difference between the average time and a theoretical time that was predetermined for the measurement times to a detection reference time that was predetermined as the reference for the paper-non-feed jam detection time when the average time is longer than the theoretical time, and determines that a paper-non-feed jam has occurred when the time from the start of paper feeding until when the detecting body detects the arrival of the paper is longer than the established paper-non-feed jam detection time

Further features and advantages of the present disclosure will become apparent from the description of embodiments given below.

### BRIEF DESCRIPTION OF THE DRAWINGS

FIG. 1 is a schematic cross-sectional front view of a multifunctional peripheral;

FIG. 2 is a partially enlarged schematic cross-sectional view of an image formation section;

FIG. 3 is a block diagram illustrating one example of a hardware configuration of the multifunctional peripheral;

FIG. 4 is a block diagram for describing the control of an engine unit and also describing paper-non-feed jam detection;

FIGS. 5A and 5B is a descriptive diagram for illustrating the general concepts of each of a variety of times;

FIG. 6 is a flow chart illustrating one example of the flow for setting the paper-non-feed jam detection time;

FIG. 7 is a descriptive diagram illustrating one example of data for setting the number of retry iterations; and

FIG. 8 is a flow chart illustrating one example of the flow of paper-non-feed jam detection.

### DETAILED DESCRIPTION

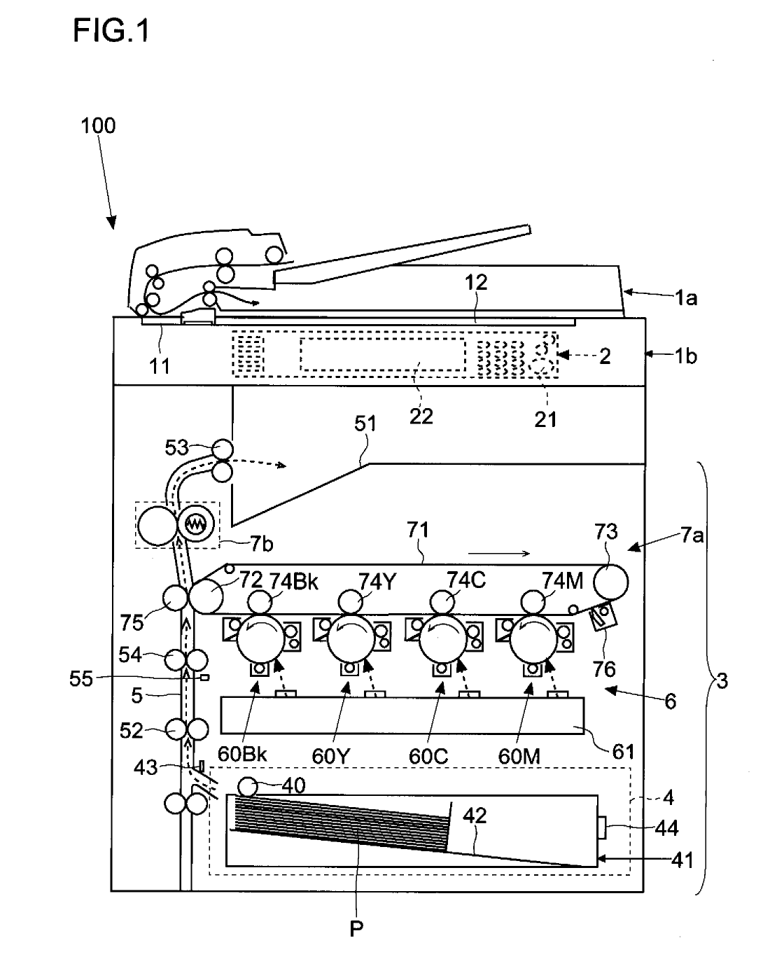

Embodiments of the present disclosure shall now be described below, with reference to FIGS. 1 to 8. The present description describes a multifunctional peripheral 100 (equivalent to an image-forming apparatus) by way of example. However, the configurations, arrangements, and various other elements set forth in each of the embodiments are merely descriptive examples, and in no way limit the scope of the disclosure.

(Summary of the Multifunctional Peripheral 100)

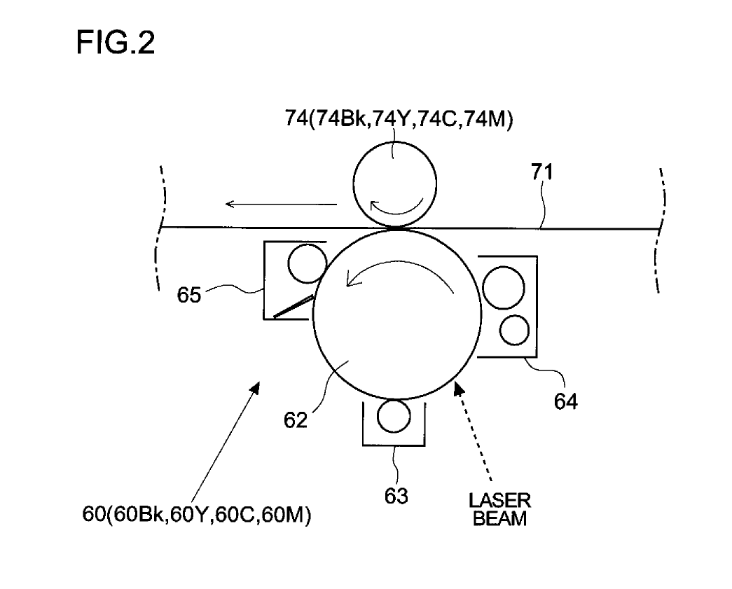

Firstly, the description shall relate to a summary of the multifunctional peripheral 100 as in the embodiment, with reference to FIGS. 1 and 2. FIG. 1 is a schematic cross-sectional front view of the multifunctional peripheral 100. FIG. 2 is a partially enlarged schematic cross-sectional view of an image formation section 6.

As illustrated in FIG. 1, a document feed unit 1a for reading an image of a document is disposed on an upper section of the multifunctional peripheral 100. An image-reading unit 1b is also disposed below the document feed unit 1a.

A document to be read is placed atop the document feed unit 1a. The document feed unit 1a conveys the document one sheet at a time toward a read position (contact glass 11 for feed reading on an upper surface of the image-reading unit 1b). The document is conveyed automatically and continuously so as to come into contact with the contact glass 11 for feed reading. The document feed unit 1a can be lifted upward, and it is also possible to place, for example, a document such as a book on a contact glass 12 for placement and reading on an upper surface of the image-reading unit 1b to carry out the reading.

Next, the image-reading unit 1b is caused to function as a scanner unit. The image-reading unit 1b reads either the document placed on the contact glass 12 for placement and reading or the document conveyed over the contact glass 11 for feed reading and forms image data of the document. Provided inside the image-reading unit 1b are optical system members such as an exposure lamp, a mirror, a lens, and an image sensor (for example, a charge-coupled apparatus (CCD)) (not shown).

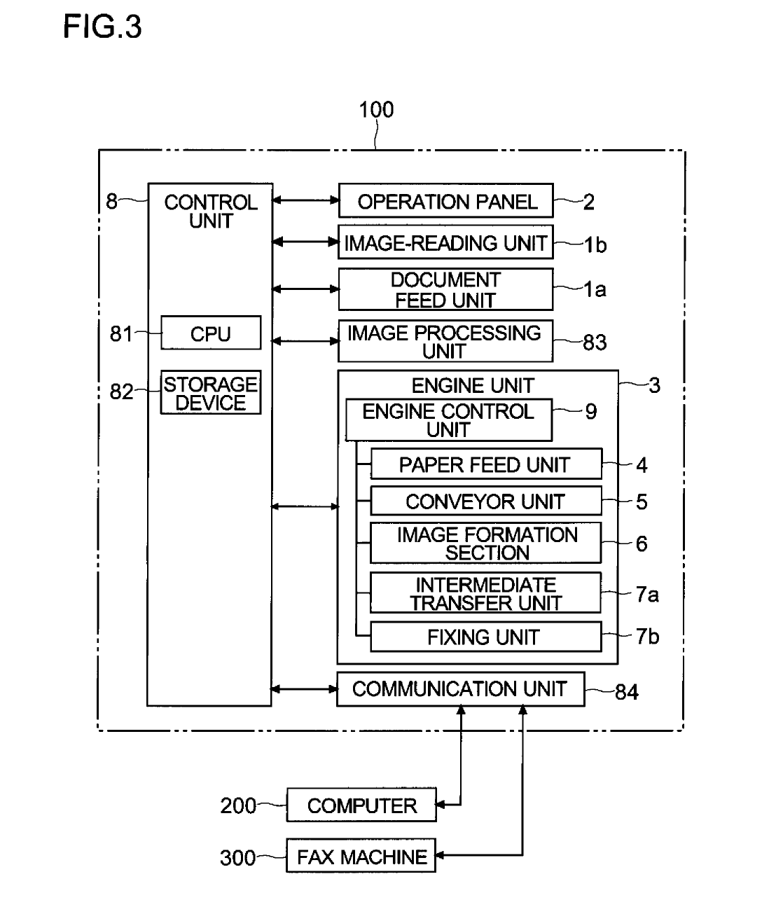

Using the optical system members, the image-reading unit 1b irradiates the document placed thereon or the document being conveyed thereover with light The image-reading unit 1b carries out the analog-to-digital (A/D) conversion of the output value of each of the pixels of the image sensor which has received the reflected light of the document, and generates image data. The multifunctional peripheral 100 is able to print on the basis of the image data obtained through reading (a copy functionality). The multifunctional peripheral 100 is also able to send the image data obtained through reading to a computer 200 or the like (a scanning functionality or send functionality; see FIG. 3).

Provided on the front side of the multifunctional peripheral 100 is an operation panel 2 (equivalent to a notification unit) having a start key 21 for instructing the multifunctional peripheral 100 to begin operating and a display unit 22 (equivalent to a notification unit) (depicted with dashed lines in FIG. 1). In addition to displaying the status of the multifunctional peripheral 100, the display unit 22 also displays menus for selecting functions, keys for setting the setting values, and the like. In order to be able to recognize the menu or key that has been selected (pressed), the display unit is a liquid crystal display panel of the touch panel type.

Also provided in the interior of the multifunctional peripheral 100 is an engine unit 3 for carrying out printing (see FIG. 3). The engine unit 3 includes a paper feed unit 4, a conveyor unit 5, an image formation section 6, an intermediate transfer unit 7a, a fixing unit 7b, and the like.

The paper feed unit 4 accommodates paper P (of A4, B4, letter size or a variety of other sizes) as a recording medium and, during image formation, supplies the paper P. In FIG. 1, only one paper feed unit 4 is depicted, but the number of paper feed units 4 provided can be increased, such as by stacking in the up-down direction. The multifunctional peripheral 100 can therefore include a plurality of paper feed units 4.

The paper feed unit 4 includes a cassette 41 (corresponding to the placement unit) for accommodating and placing therein a plurality of paper P (a variety of sheets such as copy paper, plain paper, recycled paper, cardboard, overhead projection paper (OHP) sheets, and the like). Provided within the cassette 41 is a placement plate 42 on which the paper P is placed, the downstream side of which, in the paper conveyance direction, being urged upward. A paper feed roller 40 (corresponding to the paper feed rotating body) of the paper feed unit 4 rotates and issues the paper P one sheet at a time from the cassette 41 into the conveyor unit 5.

A paper feed sensor 43 (corresponding to the detecting body) is provided between the paper feed roller 40 and a resist roller pair 54 (described below). More specifically, the paper feed sensor 43 is provided at an exit of the paper feed unit 4 (in the vicinity of the downstream side of the paper feed roller 40 in the paper conveyance direction). The paper feed sensor 43 is a sensor for detecting the arrival and/or passage of the paper P having been issued forth from the placement plate 42. For example, the paper feed sensor 43 is a transmission-type optical sensor provided with an actuator for rotating upon coming into contact with the paper P. When the paper P is not present, the actuator blocks a light path between a light-emitting unit and a light-receiving unit; when the actuator comes into contact with the paper P and rotates, the light from the light-emitting unit reaches the light-receiving unit, and the output of the light-receiving unit (a sensor) changes. The paper feed sensor 43 is not limited to being a transmission-type optical sensor, but rather may also be a reflection-type optical sensor for detecting the arrival and/or passage of the paper P by the reflected light from the paper P; moreover, the paper feed sensor is not limited to being an optical sensor, but rather may also be another type of sensor (for example, an ultrasound sensor), provided that the sensor be capable of detecting the arrival and/or passage of the supplied paper P.

Also provided to the paper feed unit 4 is a mounting/detachment detection sensor 44 (equivalent to a mounting/detachment detecting body), in order to detect the cassette 41 has been mounted on or has been removed. For example, the mounting/detachment detection sensor 44 may be an interlock-type switch for coming into contact with one side of respective cassettes 41, or may be a reflection-type optical sensor, provided that the mounting-detachment detection sensor be able to detect the insertion/removal status of the cassette 41.

Also, the conveyor unit 5 conveys the supplied paper P as far as a discharge tray 51. For this reason, conveyor roller pairs 52, 53 are provided to the conveyor unit 5. Also provided to the conveyor unit 5 is the resist roller pair 54 for issuing the paper P into the intermediate transfer unit 7a so as to match the timing to that of image formation in the image formation section 6 (toner image formation).

A resist sensor 55 for detecting the arrival and/or passage of the paper at/through the resist roller pair 54 is provided to the conveyor unit 5. The resist sensor 55 can be a transmission-type optical sensor similar to the above-described paper feed sensor 43.

The description shall now relate to the image formation section 6, with reference to FIG. 2. The image formation section 6 forms an image (toner image) in order to print on the recording medium on the basis of the image data. The image formation section 6, as illustrated in FIG. 1, includes four image formation units 60Bk (black), 60C (cyan), 60M (magenta), and 60Y (yellow), as well as an exposure device 61 for scanning to expose respective photosensitive drums 62 to light on the basis of the image data to form an electrostatic latent image. Each of the image formation units 60 uses a different color of toner but has a similar fundamental configuration, and thus, in the description below, the reference symbols Bk, Y, C, M have been omitted, with the exception of cases where a particular description is being made.

As illustrated in FIG. 2, each of the image formation units 60 is supported so as to be able to rotate in the arrow direction illustrated in FIG. 2, and is provided with a photosensitive drum 62 that is rotatably driven in a predetermined direction. A charging device 63, a developing device 64, and a cleaning device 65 are also disposed around the photosensitive drum 62.

The charging device 63 uniformly charges the surface of the photosensitive drum 62 to a predetermined electric potential. The exposure device 61 scans and exposes the charged surface of the photosensitive drum 62 with light in accordance with the image data. The developing device 64 carries the toner and causes the toner, having been charged to the electrostatic latent image, to be scattered onto the photosensitive drum 62, thus developing the electrostatic latent image (transforming same into a visible image). The cleaning device 65 cleans the surface of the photosensitive drum 62. These configurations allow the toner image to be formed on the periphery of each of the photosensitive drums 62, and the toner image is primarily transferred onto an intermediate transfer belt 71.

The intermediate transfer unit 7a is provided adjacent to the image formation section 6. The intermediate transfer unit 7a accepts the primary transfer of the toner image formed on the periphery of each of the photosensitive drums 62, and secondarily transfers the toner image onto the paper P. The intermediate transfer belt 71 is stretched across a drive roller 72, a driven roller 73, four primary transfer rollers 74(74Bk,74Y,74C,74M), and the like, so that the outer peripheral surface on the lower side and each of the photosensitive drums 62 abut against each other. A driving means, such as a motor or gear (not shown) rotates and is connected to the drive roller 72. The rotation of the drive roller 72 revolves the intermediate transfer belt 71 in the clockwise direction (the arrow direction) in FIG. 1. The primary transfer rollers 74(74Bk,74Y,74C,74M) face each of the photosensitive drums 62 and are disposed so as to be able to rotate one at a time, and a voltage of a predetermined magnitude is applied to the primary transfer rollers 74(74Bk,74Y,74C,74M). The application of voltage causes the toner images of each of the colors to be primarily transferred from each of the photosensitive drums 62 onto the intermediate transfer belt 71. In the process of this primary transfer, the toner images of each of the colors are superimposed without deviation.

Also provided to the intermediate transfer unit 7a is a secondary transfer roller 75 that abuts against the intermediate transfer belt 71, faces the drive roller 72, and is rotatably supported. In accordance with the entry of the toner image on the intermediate transfer belt 71 into a nip (secondary transfer nip) of the intermediate transfer belt 71 and the secondary transfer roller 75, the resist roller pair 54 issues the paper P into the secondary transfer nip. When the toner image and the paper P enter the secondary transfer nip, a predetermined voltage is applied to the secondary transfer roller 75. The toner image is thereby secondarily transferred onto the paper P. A belt cleaning device 76 removes residual toner and the like from the intermediate transfer belt 71 and cleans same.

The fixing unit 7b affixes the transferred toner image onto the paper P. Pressure and heat are applied to the paper P in the process of passing through the fixing unit 7b, and the toner image is affixed onto the paper P. Thereafter, the paper P is discharged into the discharge tray 51, and image formation is complete.

(Hardware Configuration of the Multifunctional Peripheral 100)

The description shall now relate to the hardware configuration of the multifunctional peripheral 100 according to the embodiment, on the basis of FIG. 3. FIG. 3 is a block diagram illustrating one example of the hardware configuration of the multifunctional peripheral 100.

As illustrated in FIG. 3, the multifunctional peripheral 100 according to the embodiment has a control unit 8 in the interior thereof. The control unit 8 governs the control of the entire multifunctional peripheral 100. For example, the control unit 8 includes a CPU 81, a storage device 82, and the like. The control unit 8 is also connected to an image processing unit 83 for carrying out a variety of forms of image processing. During printing, image data that has been processed by the image processing unit 83 is sent to the exposure device 61. The exposure device 61 scans to expose each of the photosensitive drums 62 to light on the basis of the image data, processed by the image processing unit 83, for respective pages.

The CPU 81 is a central computation processing device, and carries out controls and/or computations for each of the parts of the multifunctional peripheral 100, on the basis of a control program that is stored in and opened from the storage device 82. The storage device 82 is constituted of a plurality of types of recording media, such as a ROM, RAM, HDD, or flash ROM. The storage device 82 stores: a program for controlling the multifunctional peripheral 100; data for control; setting data; and image data obtained by the scanner in the image-reading unit 1b.

The control unit 8 is connected to the document feed unit 1a, the image-reading unit 1b, the engine unit 3 inside the multifunctional peripheral 100 (the print-related portions, such as the paper feed unit 4, the conveyor unit 5, the image formation section 6, and the fixing unit 7b), the operation panel 2, and the like, and controls the operations of each of the parts on the basis of the control program and/or data of the storage device 82 so that image formation is carried out properly. The control unit 8 may also be segmented into each functionality, such as into a main control unit for carrying out overall control of image processing, a communication control unit for controlling communication, and the like, and also a plurality of types of portions for carrying out control may be provided.

Provided to the engine unit 3 is an engine control unit 9 (equivalent to a determination unit) for accepting an instruction of the control unit 8 and actually controlling the operation of the engine unit 3. The engine control unit 9 controls paper conveyance, image formation, fixing, and the like during printing, on the basis of the instruction of the control unit 8 (described in greater detail below).

The control unit 8 is further connected to a communication unit 84 provided with a variety of connectors, a socket, a chip for communication control, and the like. A network, cable, public telephone line, or the like connects the communication unit 84 to a computer 200 (for example, a personal computer or a server), a paired fax machine 300, and the multifunctional peripheral 100 so as to allow communication therebetween. For example, the communication unit sends to the external computer 200 or fax machine 300 (optionally by e-fax) the image data obtained by the reading at the image-reading unit 1b (scanner/fax functionality). The communication unit also receives image data from the external computer 200 or fax machine 300, and is able either to collect the received image data in the storage device 82 or print a hardcopy on the basis of the data (printer/fax functionality).

(Control of the Engine Unit 3 and Paper-Non-Feed Jam Detection)

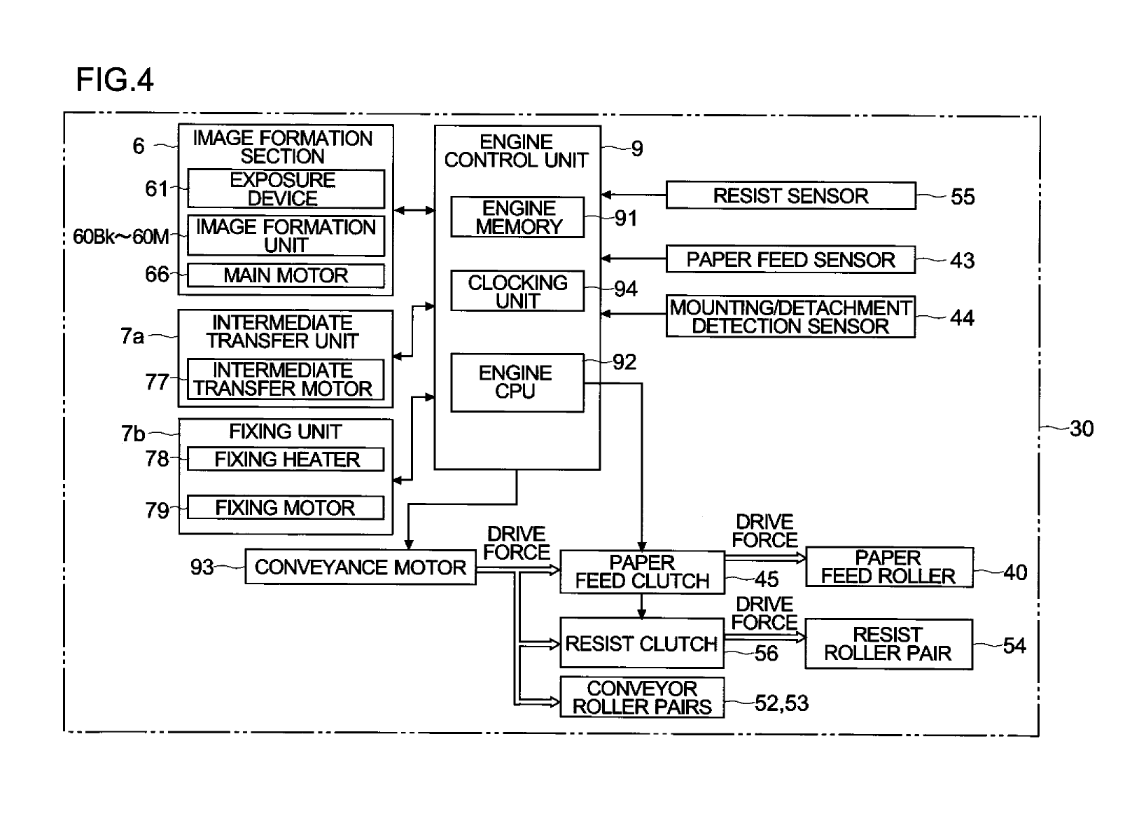

The description shall now relate to a summary of paper-non-feed jam detection in the multifunctional peripheral 100 according to the embodiment, on the basis of FIG. 4. FIG. 4 is a block diagram for describing the control of the engine unit 3 and the paper-non-feed jam detection.

Firstly, the engine control unit 9 is provided to the engine unit 3. The engine control unit 9 carries out computation and processing for controlling paper conveyance and image formation (toner image formation). The engine control unit 9 includes an engine memory 91 (equivalent to a storage unit) for storing a program and/or data for controlling each of the portions included in the engine unit 3. Also provided to the engine control unit 9 is an engine CPU 92. The engine CPU 92 controls the operations of the portions included in the engine unit 3 on the basis of the program and/or data stored in the engine memory 91. For example, the engine CPU 92 controls paper feeding, paper conveyance, the timing for forming the toner image, and the like.

The engine control unit 9 controls the operation of the exposure device 61 of the image formation section 6, and causes same to scan to expose the photosensitive drums 62 of each of the colors to light. During the execution of a print job, the engine control unit 9 also controls the application of voltage in the image formation unit 60, and the like, and causes operations relating to the electrostatic latent image and the development thereof, such as charging and development, to be carried out. Also, during the execution of a print job, the engine control unit 9 causes a main motor 66, which rotates a rotating body provided to each of the image formation units 60, to be driven.

Further, during execution of a print job, the engine control unit 9 causes an intermediate transfer motor 77, which rotates the intermediate transfer belt 71 of the intermediate transfer unit 7a, to operate, and causes the intermediate transfer belt 71 to revolve. During execution of a print job, the engine control unit 9 also controls the application of voltage to each of the transfer rollers, and controls the transfer of the toner image onto the intermediate transfer belt 71 and onto the paper P.

During execution of a print job, the engine control unit 9 further controls the temperature of the fixing unit 7b using a fixing heater 78 provided to the fixing unit 7b. Also, during execution of a print job, the engine control unit 9 causes an fixing motor 79, which rotates a rotating body for applying heat and/or pressure to the paper P onto which the toner image at the fixing unit 7b has been transferred, to be driven.

The engine control unit 9 also controls the conveying and supplying of paper inside the multifunctional peripheral 100 from the paper feed unit 4 toward the discharge tray 51. The paper feed roller 40, the resist roller pair 54, the conveyor roller pairs 52, 53, and the like are provided as the rotating bodies for rotating in order to convey the paper P. Also provided inside the multifunctional peripheral 100 is a conveyance motor 93 for rotating the rotating bodies for paper feeding and/or for conveyance. There may be provided a plurality of the motors used for paper feeding and/or paper conveyance, such that there is one used for the paper feed roller 40 and one for the resist roller pair 54.

When carrying out paper feeding or paper conveyance, the engine control unit 9 causes the conveyance motor 93 to rotate. The drive force for the rotation of the conveyance motor 93 is transferred to the paper feed roller 40, the resist roller pair 54, and the conveyor roller pairs 52, 53 via a gear train (not shown) connected to a drive shaft of the conveyance motor 93.

When carrying out continuous paper feeding from the paper feed unit 4, the engine control unit 9 feeds successive sheets of paper spaced apart. For this reason, the engine control unit 9 repeatedly rotates and stops the paper feed roller 40. The engine control unit 9 also sets the resist roller pair 54 in a stopped state at the start of paper arrival and then, after skew is corrected by deflection, causes the resist roller pair to rotate in accordance with the formation of the toner image in the image formation section 6. In this manner, when a plurality of sheets of the paper P are being consecutively printed, the paper feed roller 40 and the resist roller pair 54 are temporarily stopped when the conveyance of one page during a print job (during paper conveyance) is complete.

In view whereof, a paper feed clutch 45 and a resist clutch 56 are provided to paths for transmitting drive force to the paper feed roller 40 and the resist roller pair 54, respectively. Each of the clutches 45, 56 is an electromagnetic clutch. The engine control unit 9 controls the linking and release of each of the clutches 45, 56. Also, in order to properly convey the paper P and form an image, the engine control unit 9 causes the paper feed roller 40 and the resist roller pair 54 to rotate at a predetermined timing. An electromagnetic clutch may also be provided to each of the conveyor roller pairs 52, 53, to control the on/off status of the rotation of each of the conveyor roller pairs 52, 53.

In the multifunctional peripheral 100 of the present embodiment, a paper feed sensor 43 is provided in order to detect whether paper has been properly fed from the paper feed roller 40. The output of the paper feed sensor 43 is inputted to the engine control unit 9. After having checked the output of the paper feed sensor 43, turned on the paper feed clutch 45, and starting paper feed (after the start of paper feed), the engine control unit 9 measures the time from then until when the paper feed sensor 43 detects the arrival of the paper (a measurement time).

Every time the measurement time is measured, the measurement time is stored as measurement data in the engine memory 91 (alternatively, in the storage device 82). In order to find (establish) a paper-non-feed jam detection time T3, the engine control unit 9 finds the average time for the measurement times on the basis of the measurement data stored in the engine memory 91 (the measurement times of each of the pages) (described in greater detail below).

In order for the average time to be easier to find, the engine control unit 9 may also store in the engine memory 91 data obtained by reprocessing the measurement times, as the measurement data. For example, every time the measurement time is measured, the engine control unit 9 would update and store in the engine memory 91 the cumulative total of the measurement times of each of the pages as well as the cumulative total number of pages for which the measurement time has been measured. In such a case, when the measurement time has been measured, the engine control unit 9 can find the average time by dividing the most recent cumulative total of the measurement times, obtained by adding the measurement time most recently measured to the cumulative total of measurement times obtained up to that point, by a value obtained by adding “1” to the cumulative total number of pages obtained up to that point.

The measurement time may be clocked by a clocking unit 94 provided inside the engine control unit 9 or may be clocked using a clocking functionality of the engine CPU 92. When the paper feed sensor 43 has not detected the arrival of paper within the paper-non-feed jam detection time T3 since the start of paper feeding (since the start of rotation of the paper feed roller 40 by the linking of the paper feed clutch 45), then the engine control unit 9 understands a paper-non-feed jam to have occurred, and stops the image formation operations, such as paper feeding, paper conveyance, and image formation (toner image formation).

Further, a resist sensor 55 is provided in order to detect whether the paper P has arrived at the resist roller pair 54. The output of the resist sensor 55 is inputted to the engine control unit 9. The engine control unit 9 checks for a change in the output of the resist sensor 55 to check for whether or not the paper P has arrived at the resist roller pair 54 (whether or not a paper non-arrival has occurred) to ensure the paper is present when the image (toner image) arrives at the secondary transfer nip of the drive roller 72 and the secondary transfer roller 75.

(Flow for Setting the Paper-Non-Feed Jam Detection Time T3)

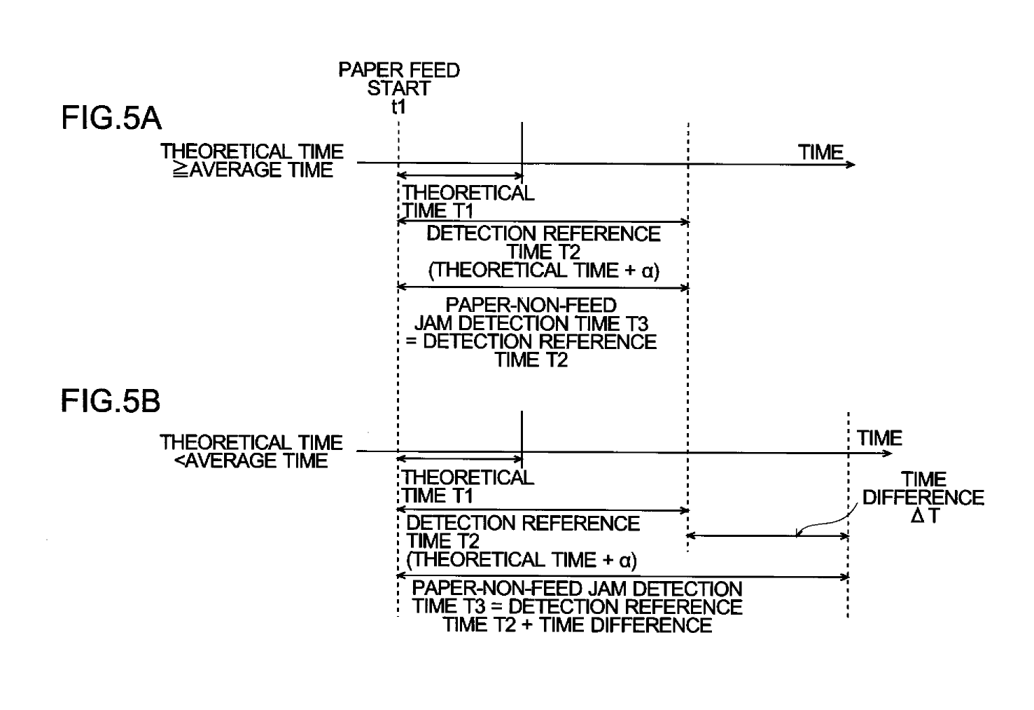

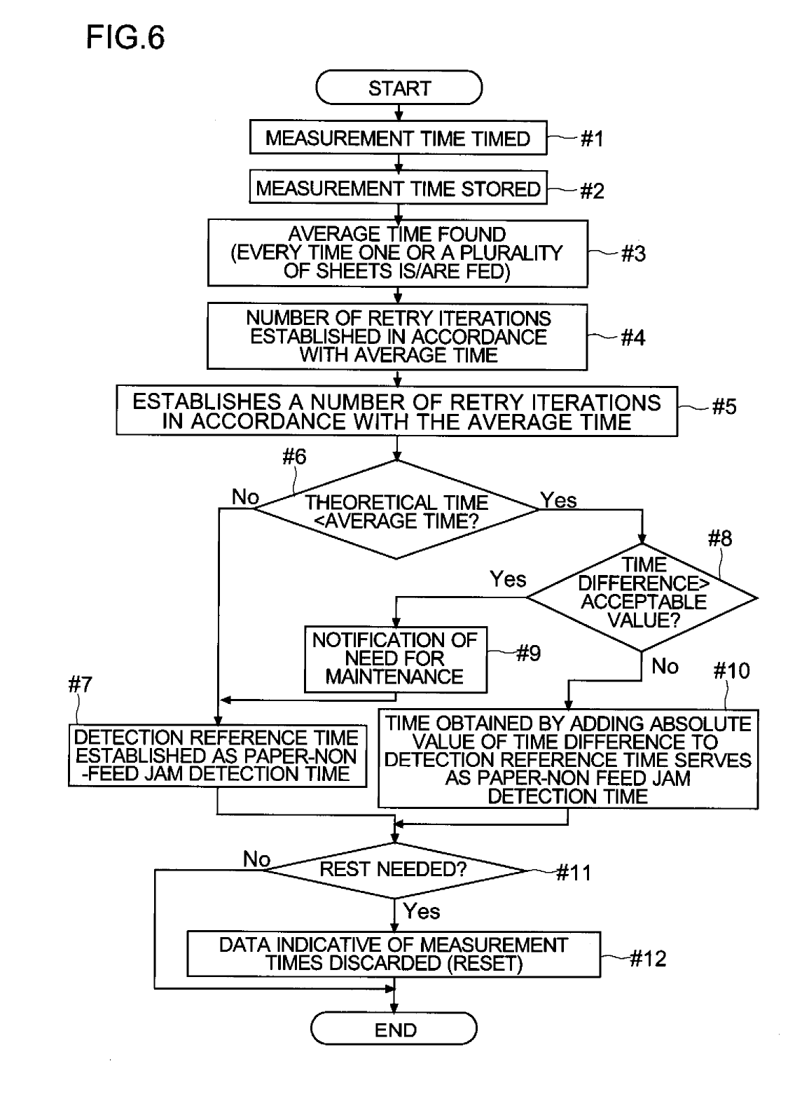

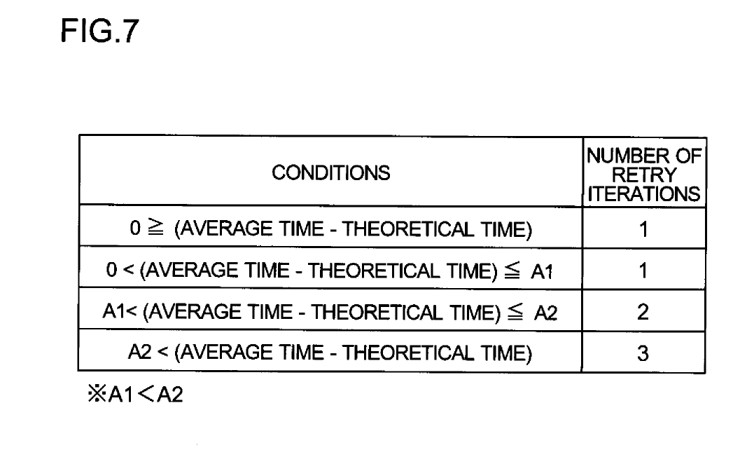

The description shall now relate to one example of the flow for setting the paper-non-feed jam detection time T3, with reference to FIGS. 5 to 7. FIGS. 5A and 5B is a descriptive diagram for describing the general concepts of each of a variety of times. FIG. 6 is a flow chart illustrating one example of the flow for setting the paper-non-feed jam detection time T3. FIG. 7 is a descriptive diagram illustrating one example of data for setting the number of retry iterations.

The description shall first relate to each of the variety of times involved in finding the paper-non-feed jam detection time T3, with reference to FIGS. 5A and 5B.

In the multifunctional peripheral 100 of the present embodiment, the engine control unit 9 measures, as the measurement time, the time from the start of rotation of the paper feed roller 40 (a point in time t1 in FIGS. 5A and 5B) until when the paper feed sensor 43 detects the arrival of paper.

A theoretical time T1 is established with respect to the measurement time. This “theoretical time T1” is an ideal time from the start of rotation of the paper feed rotating body (the paper feed roller 40) (the start of paper feeding) to when the detecting body (the paper feed sensor 43) detects the paper P. There are many ways to establish the theoretical time T1 (the “theoretical time T1” can be established as desired). For example, the theoretical time T1 could be found by dividing the distance from the leading edge of the paper P having been correctly set on the cassette 41 (being at a reference position) to the paper feed sensor 43, by a paper conveyance speed that is ideal in terms of the specifications (the peripheral speed of the paper feed roller 40). The theoretical time T1 may also be experimentally established on the basis of measurement results, by actually measuring in advance through experimentation the time from the start of rotation of the paper feed roller 40 until the detection of the arrival of the paper by the paper sensor 43.

Also established in advance is a detection reference time T2, as a reference for the paper-non-feed jam detection time T3, which is a time adapted for determining whether or not a paper-non-feed jam has occurred. This “detection reference time T2” is a time which is established in the development and design of the image-forming apparatus (the multifunctional peripheral 100), and can be established as desired. As illustrated in FIGS. 5A and 5B, the “detection reference time T2” is a time obtained by adding a design-related margin time that takes delay factors into consideration, such as slipping of the paper feed rotating body (the paper feed roller 40), to the time (the theoretical time T1) from the start of rotation of the paper feed rotating body (the paper feed roller 40) (the start of paper feeding) until when the detecting body (the paper feed sensor 43) detects the paper P (where the detection reference time T2 is greater than the theoretical time T1). For example, when the theoretical time T1 is 100 milliseconds, then the detection reference time T2 is made to be 250 milliseconds to fulfill the relationship “detection reference time T2>theoretical time T1.”

Also, in the present embodiment, when the average time of the measurement times is the theoretical time T1 or shorter, then the engine control unit 9 establishes the detection reference time T2 as being the paper-non-feed jam detection time T3, as is illustrated in FIG. 5A. In other words, when the measurement time during paper feeding is on average shorter than the theoretical value (reference value) and there is no delay, the engine control unit 9 understands the paper-non-feed jam detection time T3 to be the predetermined detection reference time T2. The engine control unit 9 determines that a paper-non-feed jam has occurred when the paper feed sensor 43 does not detect the arrival of paper even though the paper-non-feed jam detection time T3 has elapsed since the start of rotation of the paper feed roller 40.

In the present embodiment, when the average time of the measurement times is longer than the theoretical time T1, then, as shown in FIG. 5B, a time obtained by adding the absolute value of a time difference ΔT between the average time and the theoretical time T1 to the detection reference time T2 is established by the engine control unit 9 as being the paper-non-feed jam detection time T3. In other words, when the measurement time during paper feeding is on average longer than the theoretical value (reference value) and a tendency toward delay is observed, then the engine control unit 9 causes the paper-non-feed jam detection time T3 to be longer than the predetermined detection reference time T2.

Gradual aging (abrasion) of the paper feed roller 40 is one factor for the delay in paper feeding to take place. However, a variety of factors for the delay in paper feeding to occur exist. The extent of delay or advancing of paper feeding varies depending on the state in which the paper P is set (placed) on the paper feed unit 4 (the cassette 41) and/or the degree to which the paper P having been set thereon is prone to slipping (the smallness of the coefficient of friction). Moreover, individual differences depending on the image-forming apparatus or the paper feed unit 4 also exist in terms of the degree to which a delay in paper feeding is prone to take place. In view whereof, in the present embodiment, the engine control unit 9 sets the paper-non-feed jam detection time T3 to a time whereby the actual circumstances of conveyance (the circumstances of a delay in paper feeding) are reflected and given consideration.

Herein, the theoretical time T1, the detection reference time T2, and the measurement times of each of the pages (of the paper P) (the measurement data) are stored in the engine memory 91 (alternatively, in the storage device 82). The engine control unit 9 consults each of the variety of times stored in the engine memory 91 or the like as needed.

The description shall now relate to one example of the flow for setting the paper-non-feed jam detection time T3, on the basis of FIG. 6. Firstly, the START in FIG. 6 is the point in time when the paper feed roller 40 rotates and paper feeding is started. The present embodiment describes an example where the paper-non-feed jam detection time T3 is found (established) for every sheet of paper feed, but the paper-non-feed jam detection time T3 may also be found again and again (updated) once every time a plurality of sheets (several pages to several tens of pages) of paper are fed.

The engine control unit 9 then measures the measurement time (step #1). When a paper-non-feed jam does occur, the measurement time is not timed, and thus may not be counted as measurement time, the flow then being terminated. The engine control unit 9 then stores the measurement time in the engine memory 91 or the like (step #2).

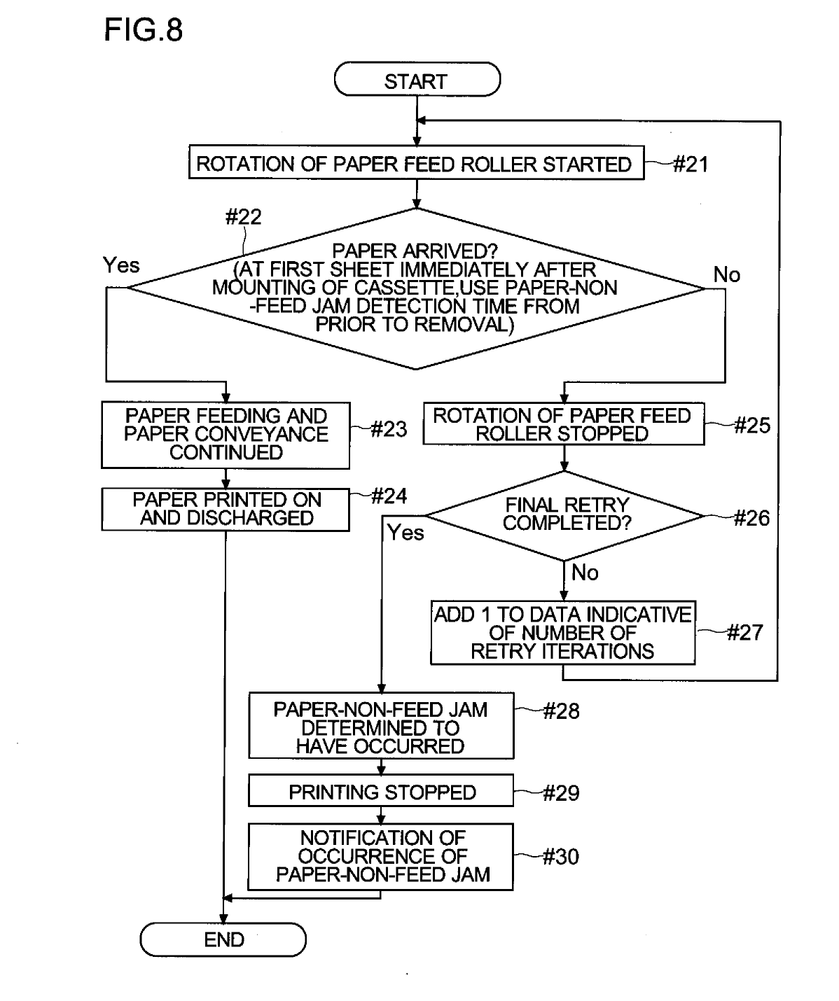

Next, using the measurement times stored in the engine memory 91 or the like, the engine control unit 9 finds the average time of the measurement times of each of the sheets of paper P having been supplied since the mounting of the cassette 41 immediately prior until the present moment (step #3). In the multifunctional peripheral 100 of the present embodiment, data indicative of the measurement time (measurement data) is reset whenever the cassette 41 is mounted (described in greater detail below). The average time is not found, and thus upon feeding of the first sheet of paper immediately after the cassette 41 is mounted, the engine control unit 9 uses the detection reference time T2 or the paper-non-feed jam detection time T3 from prior to the mounting of the cassette 41 to detect whether or not a paper-non-feed jam has occurred (see FIG. 8, step #22). In such a case, steps #3 to #10 of the flow may be skipped. The engine control unit 9 consults the theoretical time T1 stored in the engine memory 91 to find the time difference ΔT between the average time and the theoretical time T1 (step #4).

Next, the engine control unit 9 establishes a number of retry iterations, in accordance with the average time thus found (step #5). Herein, when the paper feed sensor 43 is unable to detect the arrival of paper by the time the paper-non-feed jam detection time T3 has elapsed since the start of rotation of the paper feed roller 40, then the engine control unit 9 of the present embodiment does not immediately determine that a paper-non-feed jam has occurred, but rather temporarily stops the paper feed roller 40 and thereafter again starts the rotation of the paper feed roller 40, to again carry out paper feeding (carries out a retry). When the paper feed sensor 43 is unable to detect the arrival of the paper P even though the paper-non-feed jam detection time T3 has elapsed since the start of rotation of the paper feed roller 40, despite the fact that a final retry was carried out, then the engine control unit 9 determines that a paper-non-feed jam has occurred.

The engine control unit 9 establishes the number of retry iterations such that more retry iterations happen when the average time is longer. The engine memory 91 (alternatively, the storage device 82) stores data for setting the number of retry iterations as is illustrated in FIG. 7. The data for setting the number of retry iterations is data whereby the number of retry iterations is established in accordance with the magnitude of the time difference ΔT between the average time and the theoretical time T1. The data for setting the number of retry iterations may also be data whereby the number of retry iterations is established directly in accordance with the magnitude of the average time.

In the example in FIG. 7, there are a greater number of retry iterations when the average time is longer. For example, in a ease where the average time is shorter than the theoretical time T1 or when the average time is longer than the theoretical time T1 but the absolute value of the time difference ΔT falls within A1 (for example, about several tens of milliseconds), then the number of retry iterations is one. Also, in the example in FIG. 7, when the average time is longer than the theoretical time T1 and the absolute value of the time difference ΔT is longer than A1 and falls within a range up to A2 (for example, about several tens of milliseconds to 200 milliseconds), then the number of retry iterations is two. Further, when the average time is longer than the theoretical time T1, the time difference is enlarged and the absolute value of the time difference ΔT is greater than A2, and a paper-non-feed jam is prone to occur (when the delay in paper feeding has become greater), then the number of retry iterations is further increased (for example, three). In this manner, the number of retry iterations is increased more when a paper-non-feed jam is more prone to occur, to curb the detection of the occurrence of a paper-non-feed jam. A1 and A2 can be established as appropriate, with consideration given to elements such as the paper conveyance speed and the distance from the paper feed unit 4 to the paper feed sensor 43.

The engine control unit 9 then checks for whether or not the average time is longer than the theoretical time T1 (step #6). In the event that the average time is the theoretical time T1 or shorter (“No” in step #6), the engine control unit 9 establishes the detection reference time T2 as the paper-non-feed jam detection time T3 (step #7). The flow then proceeds to step #11 (described in greater detail below).

By contrast, when the average time is longer than the theoretical time T1 (when there is a tendency toward delay in paper feed; “Yes” in step #6), then the engine control unit 9 checks for whether or not the time difference ΔT between the average time and the theoretical time T1 is greater than an acceptable value (step #8). Herein, the “acceptable value” is a value (time) that can be established as desired. For example, “the acceptable value” is a value for deciding whether or not the absolute value of the time difference ΔT is large enough that the paper feed rotating body (the paper feed roller 40) or the like needs maintenance or needs to be replaced.

In the event that the acceptable value is exceeded (“Yes” in step #8), the engine control unit 9 causes the display unit 22 of the operation panel 2 to provide notification that a portion related to paper feeding, such as the paper feed roller 40, needs maintenance (step #9). In order to deliberately cause a paper-non-feed jam to more readily take place, so that the user will be more aware of the need for maintenance, the flow transitions to step #7.

However, if the acceptable value is not exceeded (“No” in step #8), the engine control unit 9 establishes a time found by adding the absolute value of the time difference ΔT between the theoretical time T1 and the average time to the detection reference time T2, as being the paper-non-feed jam detection time T3 (step #10).

After steps #7 and #10, the engine control unit checks for whether or not it is necessary to reset the measurement times stored in the engine memory 91 or the like (the measurement data) before the next feeding of the paper P (step #11). More specifically, the engine control unit 9 checks for whether the next feeding of the paper P has been carried out without removal of the cassette 41.

In the event that removal of the cassette 41 has happened and a reset is needed (“Yes” in step #11), the engine control unit 9 discards (resets) the previously measured measurement data stored in the engine memory 91 or the like (step #12). The paper-non-feed jam detection time T3 from immediately before the cassette 41 was taken out, however, may also have been stored. Because there is a set number of sheets of paper that can be accommodated by the cassette 41, there should be provided in the engine memory 91 a capacity large enough to store a number of measurement times commensurate with the number of sheets of paper can that can be accommodated by the cassette 41 should.

In a case where no reset is needed (“No” in step #11) and after step #12, then the flow terminates. When the next paper feeding of the paper P happens, the flow begins again from the START. The engine control unit 9 detects the occurrence of a paper-non-feed jam on the basis of the paper-non-feed jam detection time T3 that has been newly established for the paper P being supplied after the paper-non-feed jam detection time T3 was established.

(Flow of Paper-Non-Feed Jam Detection)

The description shall now relate to one example of the flow for paper-non-feed jam detection in the multifunctional peripheral 100 of the present embodiment, with reference to FIG. 8. FIG. 8 is a flow chart illustrating one example of the flow for paper-non-feed jam detection.

Firstly, the START in FIG. 8 is a point in time when the engine control unit 9 begins paper feeding in order to execute a print job. The engine control unit 9 places each of the clutches 45, 56 in an ON state (a linked state) and causes the paper feed roller 40 to begin rotating (step #21).

Next, the engine control unit 9 checks for whether or not the paper feed sensor 43 has detected the arrival of the paper P by the time when the paper-non-feed jam detection time T3 has elapsed since the start of rotation of the paper feed roller 40 (step #22). In other words, the engine control unit 9 checks for whether or not the paper-non-feed jam detection time T3 has elapsed without there being a detection of the arrival of the paper P, since the start of paper feeding. The paper-non-feed jam detection time T3 that is used is the paper-non-feed jam detection time T3 that was established using the measurement times measured during the previous paper feeding, as has been described with reference to FIG. 6.

In the event that the paper feed sensor 43 has detected the arrival of the paper P by the time the paper-non-feed jam detection time T3 has elapsed since the start of rotation of the paper feed roller 40 (“Yes” in step #22), then the engine control unit 9 causes the paper feed roller 40 and/or the conveyor roller pairs 52, 53 to rotate and continues the paper feeding and the conveyance of the paper (step #23). For example, the engine control unit 9 continues the rotation of the paper feed roller 40 until a time when the paper feed sensor 43 detects the passage of the paper P, and then stops the rotation of the paper feed roller 40 after the detection of the passage of the paper.

Thereafter, the engine control unit 9 controls the image formation section 6 and the fixing unit 7b to print onto the paper P and discharge same to the discharge tray 51 (step #24), and then the flow terminates (END). For example, when printing on the paper P is carried out in a continuous fashion, this flow chart is begun anew from the START.

However, when the paper feed sensor 43 is unable to detect the arrival of the paper P by the time when the paper-non-feed jam detection time T3 has elapsed since the start of rotation of the paper feed roller 40 (“No” in step #21), then the engine control unit 9 stops the rotation of the paper feed roller 40 (step #25).

The engine control unit 9 checks for whether or not the set number of retry iterations have been executed (step #26). In other words, the engine control unit 9 checks for whether or not the final retry has been completed (step #26).

In the event that a retry still must be executed (“No” in step #26), then the engine control unit 9 adds the value “1” to the data indicative of the number of retry iterations and stores same in the engine memory 91 (step #27). The flow then returns to step #21. Therefrom, by again starting the rotation of the paper feed roller 40, the engine control unit 9 applies a rapidly changing force to the paper P to facilitate the issuing forth of the paper P from the cassette 41.

When the final retry has already been executed (“Yes” in step #26), then the engine control unit 9 determines (detects) that a paper-non-feed jam has occurred (step #28). The engine control unit 9 then stops the operation of the paper feed unit 4, the conveyor unit 5, the image formation section 6, and the like, and stops printing (step #29). The engine control unit 9 also causes the display unit 22 of the operation panel 2 to produce a display and provide notification of the occurrence of the paper-non-feed jam (step #30). The flow then ends (END).

Receiving the notification of the occurrence of the paper-non-feed jam, the user checks the conveyor unit 5 and/or the paper feed unit 4 and carries out tasks for handling the paper-non-feed jam. After the handling of the paper-non-feed jam is complete, printing starts again, in association with which the flow begins anew from step #21. When the cassette 41 has either been removed or mounted due to the occurrence of a paper-non-feed jam, the engine control unit 9 carries out processing in feeding the first sheet of paper after the paper-non-feed jam was handled, with the paper-non-feed jam detection time T3 being either the detection reference time T2 or the paper-non-feed jam detection time T3 from prior to the removal of the cassette 41, and with the number of retry iterations being either a default number of iterations (for example, one) or the number of iterations from prior to the removal of the cassette 41.

In this manner, the image-forming apparatus illustrated in the present embodiment (the multifunctional peripheral 100) includes: the image formation section 6 for forming an image; the placement unit (the cassette 41) on which a plurality of sheets of paper P to be used in printing are placed; the paper feed rotating body (the paper feed roller 40) for feeding the paper P having been placed on the placement unit toward the image formation section 6; the detecting body (the paper feed sensor 43) for detecting the arrival of the paper P having been fed from the paper feed rotating body, the detecting body being provided to a paper conveyance path (the conveyor unit 5) between the image formation section 6 and the paper feed rotating body; the storage unit (engine memory 91 or the like) for storing the measurement data that is based on the measurement times, which are the time from the start of paper feeding due to the start of rotation of the paper feed rotating body, until when the detecting body detects the arrival of the paper P; and the determination unit (the engine control unit 9) for determining that a paper-non-feed jam has occurred whenever the time from the start of paper feeding until when the detecting body detects the arrival of the paper P is longer than the paper-non-feed jam detection time T3. The determination unit finds the average time of the measurement times and, when the average time is longer than the theoretical time T1 that was predetermined for the measurement times, establishes as the paper-non-feed jam detection time T3 the time obtained by adding the absolute value of the time difference ΔT between the theoretical time T1 and the average time to the detection reference time T2 that was predetermined as the reference for the paper-non-feed jam detection time T3. The determination unit then determines whether or not a paper-non-feed jam has occurred on the basis of the established paper-non-feed jam detection time T3.

The paper-non-feed jam detection time T3 is thus extended whenever the average time is longer than the theoretical time T1 and a tendency toward a delay in paper feeding is observed. As such, the paper-non-feed jam detection time T3 can be set in accordance with the individual properties of the image-forming apparatus (the multifunctional peripheral 100) and the actual circumstances of paper feeding, and frequent detection of the occurrence of a paper-non-feed jam in excess of what is needed can be prevented. It is also possible to reduce the number of iterations of stopping the print operation of the image-forming apparatus (the multifunctional peripheral 100) and of iterations of tasks for handling a paper-non-feed jam, caused by the detection of the occurrence of a paper-non-feed jam, and ease of use for the user can be enhanced.

The paper P is sometimes replaced in association with the removal of the placement unit (the cassette 41). The type of paper P (in terms of surface slipperiness, thickness, and the like) may change between before replacement and after replacement. The placement state of the paper P may also change in association with the removal of the placement unit. In view whereof, the image-forming apparatus (the multifunctional peripheral 100) has the mounting/detachment detecting body (the mounting/detachment detection sensor 44) for detecting the mounting/removal of the placement unit, and the determination unit (the engine control unit 9) finds the average time on the basis of the measurement times from after the mounting of the placement unit to when the placement unit is next removed, to establish the paper-non-feed jam detection time T3. The basis for finding the average time is thus reset every time the placement unit is removed and the state of the paper P placed thereon changes. As such, the average time can be found and the paper-non-feed jam detection time T3 can be established in accordance with a change in the placement state or type of the paper P.

It is also assumed that with a greater extent of delay in paper feeding, the paper feed rotating body (the paper feed roller 40) will be correspondingly more likely to slip, and it will also be correspondingly more difficult to issue the paper P forth from the placement unit (the cassette 41). In view whereof, the paper feed rotating body carries out a retry, in which rotation, after having been started, is temporarily stopped and then restarted to feed out the paper; with a longer average time, the paper feed rotating body carries out a correspondingly greater number of retry iterations. The determination unit (the engine control unit 9) determines that a paper-non-feed jam has occurred after the final retry of the paper feed rotating body is completed. This makes it possible to increase the number of retry iterations when there is a possibility that it will become more difficult to issue the paper P forth from the placement unit (the cassette 41). This makes it possible to increase the number of iterations for facilitating the issuing forth of the paper P, and possible to lower the frequency of detection of the occurrence of a paper-non-feed jam.

The image-forming apparatus (the multifunctional peripheral 100) also has the notification unit (the operation panel 2 and the display unit 22) for producing a notification; when the average time is longer than the theoretical time T1 and the absolute value is greater than the predetermined acceptable value, the notification unit (the operation panel 2 and the display unit 22) produces a notification for prompting maintenance relating to paper feeding. This makes it possible to notify the user of the need for maintenance whenever the average time is longer (whenever the paper-non-feed jam detection time T3 is longer) and there is a clear and prominent delay in paper feeding.

The determination unit (the engine control unit 9) establishes the detection reference time T2 as the paper-non-feed jam detection time T3 when the average time is longer than the theoretical time T1 and the absolute value is greater than the predetermined acceptable value, and then determines whether or not a paper-non-feed jam has occurred. This makes it possible, in addition to the notification prompting maintenance, to deliberately make the occurrence of a paper-non-feed jam more likely to be detected, and more definitively ensure the user is aware that maintenance is needed.

The determination unit (the engine control unit 9) establishes the detection reference time T2 as the paper non-feed jam detection time T3 whenever the theoretical time T1 is the average time or longer, and then determines whether or not a paper-non-feed jam has occurred. This makes it possible for the paper-non-feed jam detection time T3 to match the shortest possible time, in terms of design and specification, whenever the average time is shorter than the theoretical time T1 and a delay in paper feeding is not observed. This makes it possible to promptly detect the occurrence of a paper-non-feed jam whenever the paper P is not being issued forth.

When the determination unit (the engine control unit 9) determines that a paper-non-feed jam has occurred, the paper feed rotating body (the paper feed roller 40) stops paper feeding and the image formation section 6 stops image formation. This makes it possible to avoid more severe jamming of the paper P and to forgo unneeded toner image formation.

The determination unit (the engine control unit 9) establishes the paper-non-feed jam detection time T3 every time one sheet or, alternatively, a plurality of sheets of paper is/are fed. When the paper-non-feed jam detection time T3 is established for every one sheet feeding, then the paper-non-feed jam detection time T3 can be set accurately, so as to prevent frequent paper-non-feed jam detection in accordance with the actual circumstances of paper feeding, while also consideration is being given to the individual properties of the image-forming apparatus (the multifunctional peripheral 100). When the paper-non-feed jam detection time T3 is established every time a plurality of sheets of paper are fed, then it is possible to lighten the burden on the determination unit in the processing for setting the paper-non-feed jam detection time T3.

At the feeding of the first sheet of paper immediately after the placement unit (the cassette 41) has been mounted, the determination unit (the engine control unit 9) determines whether or not a paper-non-feed jam has occurred using the paper-non-feed jam detection time T3 that was established prior to the removal of the placement unit. This makes it possible, immediately after the placement unit (the cassette 41) has been mounted thereon, to detect a paper-non-feed jam with a paper-non-feed jam detection time T3 that is in accordance with the individual properties of the image-forming apparatus (the multifunctional peripheral 100) and the actual circumstances of paper feeding.

The present disclosure can also be regarded as being the disclosure of a method.

The description shall now relate to other embodiments. The embodiment above describes an example where one paper feed unit 4 is provided, but there may also be provided a plurality of paper feed units 4. There may be provided a plurality of paper feed sensors 43, according to the number of paper feed units 4. The engine control unit 9 may also measure the measurement time for every paper feed unit 4, find the average time for every paper feed unit 4, and establish the paper-non-feed jam detection time T3 and/or the number of retry iterations for every paper feed unit 4.

The cassette 41 for accommodating the paper P was illustrated by way of example as one example of the placement unit for placing the paper P thereon. However, the placement unit may also be a tray, such as a manual paper feed tray, and is not limited to being the cassette 41. Further, an example where the paper feed sensor 43 was used in measuring the measurement time was described, but the resist sensor 55 may also be used in place of the paper feed sensor 43. In such a case, a time obtained by measuring from after the start of paper feeding (the start of rotation of the paper feed roller 40) until the arrival of the paper as per the resist sensor 55 may be used as the measurement time. Additionally, the embodiment above described an example where the display provided notification of the need for maintenance of the paper feed unit 4, but the notification may also be provided in an audible or other form.

What is claimed is:

1. An image-forming apparatus, comprising:
an image formation section for forming an image;
a placement unit on which a plurality of sheets of paper to be used in printing are placed;
a paper feed rotating body for feeding the paper having been placed on the placement unit toward the image formation section;
a detecting body for detecting the arrival of the paper having been supplied by the paper feed rotating body, the detecting body being provided to a paper conveyance path between the image formation section and the paper feed rotating body;
a storage unit for storing measurement data that is based on a measurement time, which is a time from the start of paper feeding due to the start of rotation of the paper feed rotating body to when the detecting body detects the arrival of the paper; and
a determination unit for determining whether or not a paper-non-feed jam has occurred on the basis of a paper-non-feed jam detection time; finding the average time of the measurement times; establishing as the paper-non-feed jam detection time a time obtained by adding the absolute value of the time difference between the average time and a theoretical time that is predetermined for the measurement times to a detection reference time that is predetermined as a reference for the paper-non-feed jam detection time when the average time is longer than the theoretical time; and determining that a paper-non-feed jam has occurred when the time from the start of paper feeding to when the detecting body detects the arrival of the paper is longer than the established paper-non-feed jam detection time.

2. The image-forming apparatus as set forth in claim 1, comprising:
a mounting/detachment detecting body for detecting the mounting or removal of the placement unit,
wherein the determination unit finds the average time to establish the paper-non-feed jam detection time on the basis of the measurement times from the mounting of the placement unit to the subsequent removal thereof.

3. The image-forming apparatus as set forth in claim 1,
wherein the paper feed rotating body carries out a retry in which rotation, after having been started, is temporarily stopped and then restarted to feed out the paper, the paper feed rotating body carries out a higher number of retry iterations at a correspondingly longer average time, and
the determination unit determines that a paper-non-feed jam has occurred after the final retry of the paper feed rotating body is completed.

4. The image-forming apparatus as set forth in claim 1, comprising:
a notification unit for producing a notification,
wherein the notification unit produces a notification prompting maintenance relating to paper feeding when the average time is longer than the theoretical time and the absolute value is greater than a predetermined acceptable value.

5. The image-forming apparatus as set forth in claim 4,
wherein the determination unit establishes the detection reference time as the paper-non-feed jam detection time and determines whether or not a paper-non-feed jam has occurred when the average time is longer than the theoretical time and the absolute value is greater than a predetermined acceptable value.

6. The image-forming apparatus as set forth in claim 1,
wherein the determination unit establishes the detection reference time as the paper-non-feed jam detection time and determines whether or not a paper-non-feed jam has occurred when the theoretical time is the average time or longer.

7. The image-forming apparatus as set forth in claim 1,
wherein the paper feed rotating body stops paper feeding and the image formation section stops image formation when the determination unit determines that a paper-non-feed jam has occurred.

8. The image-forming apparatus as set forth in claim 1,
wherein the determination unit establishes the paper-non-feed jam detection time every time one sheet or a plurality of sheets of paper is/are fed.

9. The image-forming apparatus as set forth in claim 2,
wherein the determination unit determines whether or not a paper-non-feed jam has occurred, by using the paper-non-feed jam detection time established before the removal of the placement unit, upon feeding of the first sheet of paper immediately after the placement unit has been mounted.

10. A method for controlling an image-forming apparatus, comprising the following steps:
causing an image formation section to form an image;
placing on a placement unit a plurality of sheets of paper to be used in printing;
causing a paper feed rotating body to feed toward the image formation section the paper having been placed on the placement unit;
causing a detecting body provided to a paper conveyance path between the image formation section and the paper feed rotating body to detect the arrival of the paper having been supplied by the paper feed rotating body;
storing measurement data that is based on a measurement time, which is a time from the start of paper feeding due to the start of rotation of the paper feed rotating body to when the detecting body detects the arrival of the paper;
finding the average time of the measurement times;
determining as a paper-non-feed jam detection time, a time obtained by adding the absolute value of the time difference between the average time and a theoretical time that is predetermined for the measurement times to a detection reference time that is predetermined as a reference for the paper-non-feed jam detection time when the average time is longer than the theoretical time;
determining whether or not a paper-non-feed jam has occurred on the basis of the paper-non-feed jam detection time; and
determining that a paper-non-feed jam has occurred when the time from the start of paper feeding to when the detecting body detects the arrival of the paper is longer than the established paper-non-feed jam detection time.

11. The method for controlling an image-forming apparatus as set forth in claim 10, further comprising:
detecting the mounting and removal of the placement unit; and
finding the average time, and establishing the paper-non-feed jam detection time on the basis of the measurement times from the mounting of the placement unit to the subsequent removal thereof.

12. The method for controlling an image-forming apparatus as set forth in claim 10, further comprising:
the paper feed rotating body being made to carry out a retry in which rotation, after having been started, is temporarily stopped and then restarted to feed out the paper,
increasing the number of retry iterations in correspondence with an increase in average time, and
a paper-non-feed jam being determined to have occurred after the final retry of the paper feed rotating body is completed.

13. The method for controlling an image-forming apparatus as set forth in claim 10, further comprising:
producing a notification for prompting maintenance relating to paper feeding being produced when the average time is longer than the theoretical time and the absolute value is greater than a predetermined acceptable value.

14. The method for controlling an image-forming apparatus as set forth in claim 13, further comprising:
establishing the detection reference time as the paper-non-feed jam detection time when the average time is longer than the theoretical time and the absolute value is greater than a predetermined acceptable value.

15. The method for controlling an image-forming apparatus as set forth in claim 10, further comprising:
establishing the detection reference time as the paper-non-feed jam detection time when the theoretical time is the average time or longer.

16. The method for controlling an image-forming apparatus as set forth in claim 10, further comprising:
stopping paper feeding by the paper feed rotating body and image formation by the image formation when a paper-non-feed jam is determined to have occurred.

17. The method for controlling an image-forming apparatus as set forth in claim 10, further comprising:
establishing the paper-non-feed jam detection time every time one sheet or a plurality of sheets is fed.

18. The method for controlling an image-forming apparatus as set forth in claim 11, further comprising:
a determination being made as to whether or not a paper-non-feed jam has occurred using the paper-non-feed jam detection time established prior to removal of the placement unit upon feeding of the first sheet of paper immediately after the placement unit has been mounted.
